(19) United States
(12) Patent Application Publication
(10) Pub. No.: US 2014/0362119 A1
(43) Pub. Date: Dec. 11, 2014

(54) ONE-HANDED GESTURES FOR NAVIGATING UI USING TOUCH-SCREEN HOVER EVENTS

(71) Applicant: MOTOROLA MOBILITY LLC, Libertyville, IL (US)

(72) Inventors: Jason L. Freund, Cupertino, CA (US); Ling Li, Buffalo Grove, IL (US); Michael D. McLaughlin, San Jose, CA (US)

(73) Assignee: MOTOROLA MOBILITY LLC, Libertyville, IL (US)

(21) Appl. No.: 13/959,032

(22) Filed: Aug. 5, 2013

Related U.S. Application Data
(60) Provisional application No. 61/831,639, filed on Jun. 6, 2013.

(51) Int. Cl. G06F 3/01; G09G 5/38; G09G 5/373

(52) U.S. Cl. CPC G06F 3/017; G09G 5/373; G09G 5/38
USPC 345/661

(57) ABSTRACT

Disclosed are a system and method for providing gesture-based user control of display functions with respect to a mobile electronic device. In an embodiment, the device is configured such that a user hover of a finger or thumb triggers a zoom and pan mode or a screen resizing and relocation function wherein the displayed material is decreased in scale and relocated to be adjacent the screen edge from whence the user is interacting with the screen.

### CROSS-REFERENCE TO RELATED APPLICATION

The present application claims priority to U.S. Provisional Patent Application 61/831,639, filed on Jun. 6, 2013, which is incorporated herein by reference in its entirety.

### TECHNICAL FIELD

The present disclosure is related generally to electronic device user-interface presentation and manipulation and, more particularly, relates to a system and method for adjusting user-interface characteristics based on a proximate user gesture.

### BACKGROUND

Portable communication, entertainment, and computing devices such as cellular telephones, tablet computers, and so on have existed for quite some time, yet their capabilities continue to expand to this day. More efficient use of the wireless spectrum and the continued miniaturization of electronic components have yielded hand-held devices that can act as stand-alone computers, network nodes, personal digital assistants, and telephones.

There was a period in mobile-device development history when device miniaturization was a paramount consideration. However, as device capabilities expanded, ease of use began to eclipse miniaturization as a primary concern. Today, for example, many mobile devices have significantly more screen area than their progenitors. Indeed, some devices, often referred to as “tablet computers” or simply “tablets,” provide a screen area comparable to that of a small laptop computer.

However, while increased screen area has made it easier for users to interface with a device's full capability, such devices are still mobile devices and are often manipulated with only one hand. This may occur, for example, when a user is holding the mobile device in one hand while holding another object in the other hand.

The discussion of any problem or solution in this Background section simply represents an observation of the inventors and is not to be taken as an indication that the problem or solution represents known prior art. The present disclosure is directed to a method and system that exhibit one or more distinctions over prior systems. However, it should be appreciated that any such distinction is not a limitation on the scope of the disclosed principles or of the attached claims except to the extent expressly noted in the claims.

### BRIEF DESCRIPTION OF THE SEVERAL VIEWS OF THE DRAWINGS

While the appended claims set forth the features of the present structures and techniques with particularity, these features, together with their objects and advantages, may be best understood from the following detailed description taken in conjunction with the accompanying drawings of which:

FIG. 1 is a generalized schematic of an example device within which the presently disclosed innovations may be implemented;

FIG. 2 is a simulated screen view showing a manipulation of the mobile electronic device to enter a hover-zoom mode by hovering a digit close to the display for a predetermined time in accordance with an aspect of the disclosure;

FIG. 3 is a simulated screen view showing a manipulation of the mobile electronic device to pan a zoomed display in accordance with an aspect of the disclosure;

FIG. 4 is a simulated screen view showing the triggering and effect of a resizing mode in accordance with an aspect of the disclosure;

FIG. 5 is a flowchart showing a process for intercepting and interpreting user hover and touch events in an embodiment to perform zooming and panning of the display; and

FIG. 6 is a flowchart showing a process for intercepting and interpreting user hover and touch events in an embodiment to perform resizing of the display.

### DETAILED DESCRIPTION

The following description is based on embodiments of the claims and should not be taken as limiting the claims with regard to alternative embodiments that are not explicitly described herein. As used herein, the term “mobile electronic device” refers to a portable device having a screen usable to receive user input used at least in part to provide telecommunications services or notifications to a user.

As noted above, when a user holds and interfaces with a mobile electronic device with a single hand, the area of the screen that the user can reach is generally reduced to an area reachable as the user pivots a finger or thumb. Although some mobile devices have a limited ability to manipulate the size and location of input elements (e.g., calculator keypad, phone keypad), this approach only enables the manipulation of device keyboards and does not enable general application and system use. It is also difficult to enable or disable the altered mode in such systems. Moreover, such systems typically require the user to physically tap the display.

In an embodiment, the device display screen is a capacitive touch screen having the ability distinguish between a touch event and a hover event. In this embodiment, hover events are intercepted and are used to activate gesture control for display scaling and panning to enable device access using one-handed navigation. In particular, hovering a digit (finger or thumb) over the screen activates a “resize” mode that temporarily shrinks the display image and moves it closer to the digit to make it more accessible.

In another aspect, a hover event is intercepted and used to trigger a zoom and pan mode, e.g., for users with poor eyesight or for when viewing small content. In both cases described, the interception and use of the hover event do not interfere with the underlying operation of running applications or require any participation from applications. In this way, a large phone display (e.g., a display that is about 5 inches or larger in diagonal measurement) can be made more accessible when only one hand of the user is available.

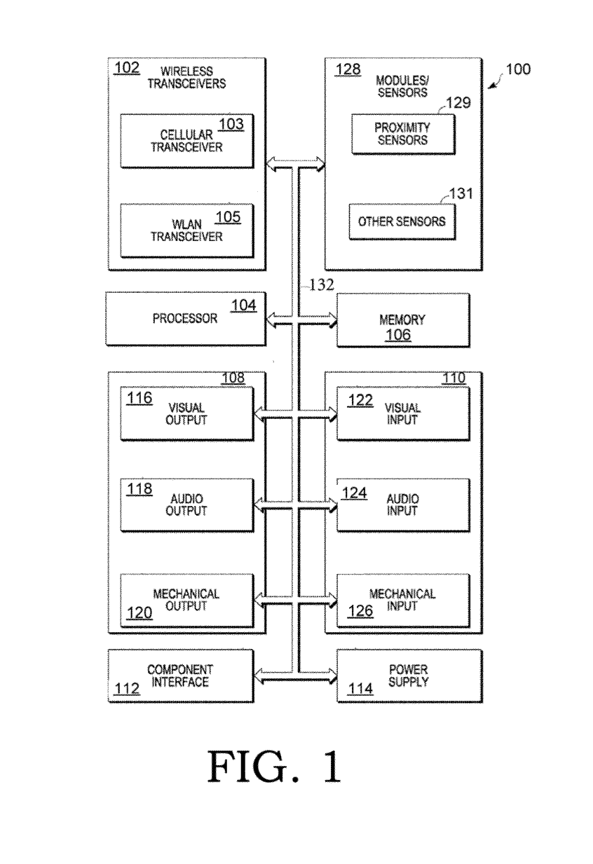

An exemplary device within which aspects of the present disclosure may be implemented is shown schematically in FIG. 1. In particular, the schematic diagram 100 illustrates exemplary internal components of a mobile smart phone implementation of a small touch-screen device. These components can include wireless transceivers 102, a processor 104, a memory 106, one or more output components 108, one or more input components 110, and one or more sensors 128. The processor 104 may be any of a microprocessor, microcomputer, application-specific integrated circuit, or the like. Similarly, the memory 106 may, but need not, reside on the same integrated circuit as the processor 104.

The device can also include a component interface 112 to provide a direct connection to auxiliary components or accessories for additional or enhanced functionality and a power supply 114, such as a battery, for providing power to the device components. All or some of the internal components may be coupled to each other, and may be in communication with one another, by way of one or more internal communication links 132, such as an internal bus.

The memory 106 can encompass one or more memory devices of any of a variety of forms, such as read-only memory, random-access memory, static random-access memory, dynamic random-access memory, etc., and may be used by the processor 104 to store and retrieve data. The data that are stored by the memory 106 can include one or more operating systems or applications as well informational data. Each operating system is implemented via executable instructions stored in a storage medium in the device that control basic functions of the electronic device, such as interaction among the various internal components, communication with external devices via the wireless transceivers 102 or the component interface 112, and storage and retrieval of applications and data to and from the memory 106.

With respect to programs, sometimes also referred to as applications, each program is implemented via executable code that utilizes the operating system to provide more specific functionality, such as file-system service and handling of protected and unprotected data stored in the memory 106. Although many such programs govern standard or required functionality of the small touch-screen device, in many cases the programs include applications governing optional or specialized functionality, which can be provided in some cases by third-party vendors unrelated to the device manufacturer.

Finally, with respect to informational data, this non-executable code or information can be referenced, manipulated, or written by an operating system or program for performing functions of the device. Such informational data can include, for example, data that are preprogrammed into the device during manufacture or any of a variety of types of information that are uploaded to, downloaded from, or otherwise accessed at servers or other devices with which the device is in communication during its ongoing operation.

The device can be programmed such that the processor 104 and memory 106 interact with the other components of the device to perform a variety of functions, including interaction with the touch-detecting surface to receive signals indicative of gestures therefrom, evaluation of these signals to identify various gestures, and control of the device in the manners described below. The processor 104 may include various modules and may execute programs for initiating different activities such as launching an application, transferring data, and toggling through various graphical user-interface objects (e.g., toggling through various icons that are linked to executable applications).

The wireless transceivers 102 can include, for example as shown, both a cellular transceiver 103 and a wireless local area network transceiver 105. Each of the wireless transceivers 102 utilizes a wireless technology for communication, such as cellular-based communication technologies including analog communications, digital communications, next generation communications or variants thereof, peer-to-peer or ad hoc communication technologies, or other wireless communication technologies.

Exemplary operation of the wireless transceivers 102 in conjunction with other internal components of the device can take a variety of forms and can include, for example, operation in which, upon reception of wireless signals, the internal components detect communication signals, and one of the transceivers 102 demodulates the communication signals to recover incoming information, such as voice or data, transmitted by the wireless signals. After receiving the incoming information from the transceivers 102, the processor 104 formats the incoming information for the output components 108. Likewise, for transmission of wireless signals, the processor 104 formats outgoing information, which may or may no be activated by the input components 110, and conveys the outgoing information to one or more of the wireless transceivers 102 for modulation as communication signals. The wireless transceivers 102 convey the modulated signals to a remote device, such as a cell tower or an access point (not shown).

The output components 108 can include a variety of visual, audio, and mechanical outputs. For example, the output components 108 can include one or more visual-output components 116 such as a display screen. One or more audio-output components 118 can include a speaker, alarm, or buzzer, and one or more mechanical-output components 120 can include a vibrating mechanism, for example. Similarly, the input components 110 can include one or more visual-input components 122 such as an optical sensor of a camera, one or more audio-input components 124 such as a microphone, and one or more mechanical-input components 126 such as a touch-detecting surface and a keypad.

The sensors 128 can include both proximity sensors 129 and other sensors 131, such as an accelerometer, a gyroscope, any haptic, light, temperature, biological, chemical, or humidity sensor, or any other sensor that can provide pertinent information, such as to identify a current location of the device.

Actions that can actuate one or more input components 110 can include, for example, powering on, opening, unlocking, moving, or operating the device. For example, upon power on, a “home screen” with a predetermined set of application icons can be displayed on the touch screen.

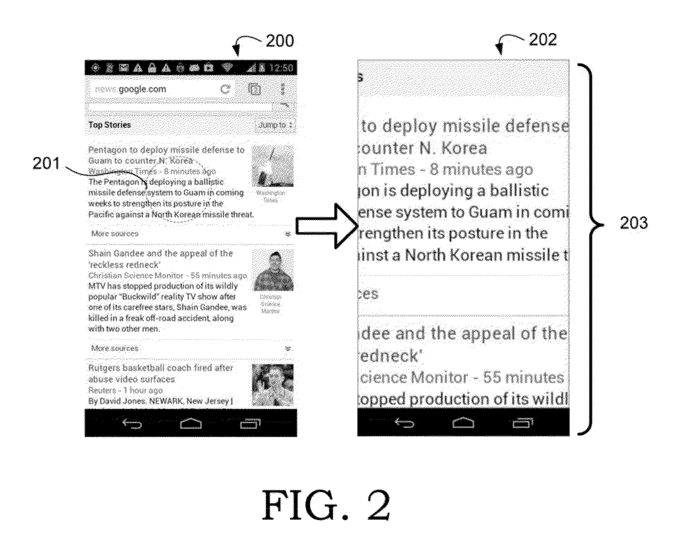

As noted above, in an aspect of the disclosure the mobile electronic device is configured to receive and interpret a hover event in order to modify the user interface of the device. FIGS. 2 through 4 represent simulated screen views showing the use of a hover gesture to zoom and pan the device display. In particular, FIG. 2 shows the use of a hover event to enter a hover-zoom mode, wherein the device is configured to interpret the distance of the user's digit from the screen as an indication of desired zoom scale.

As shown in screen 200 of FIG. 2, the user may hover a digit over a location 201 for a predetermined period of time to enter the hover-zoom mode. The predetermined period of time in an embodiment is long enough to largely avoid accidental triggering while being short enough to avoid taxing the user's patience. In keeping with this, in one aspect, the predetermined period of time is about 2 seconds. It will be appreciated that longer or shorter predetermined periods of time may be used to trigger the hover-zoom mode in any specific implementation. In addition, the predetermined period of time may be user-settable. That is, some users may prefer a longer period of time to avoid accidental triggering, while some users may prefer a shorter period of time to enable them to enter the hover-zoom mode more quickly.

Once in the hover-zoom mode, the device is configured to interpret the hover distance to determine the desired level of zoom or scale. In an embodiment, a greater distance between the screen and the user's digit is interpreted as a request for a smaller scale (e.g., up to the point that the display is of its original scale), while a smaller distance is interpreted as a request for a larger scale. It will be appreciated that the exact relationship between hover distance and scale is not important, and that, for example, closer distances may instead represent a request for a smaller scale while greater distances may instead represent a request for a larger scale.

In an embodiment, changes in hover distance rather than the magnitude of the distance are used to select a desired scale. For example, in this aspect, if the hover distance used by the user to trigger the hover-zoom mode is one centimeter, then the screen display may be scaled at 100% when the hover-zoom mode is entered. Subsequent decreases in the hover distance may then be used as described above to increase the scale of the display, and from there, increasing the distance again will result in a reduction of the display scale, e.g., back to 100%.

As shown in screen 202 of FIG. 2, the result of an increase in the display scale during the hover-zoom mode results in a portion of the displayed material being scaled upward to fit within the original display area 203. This allows the user to more easily view displayed material, e.g., text or graphics, and also allows the user to more accurately select any linked elements, e.g., drag bars, buttons, hyperlinked text, application menu items, and so on.

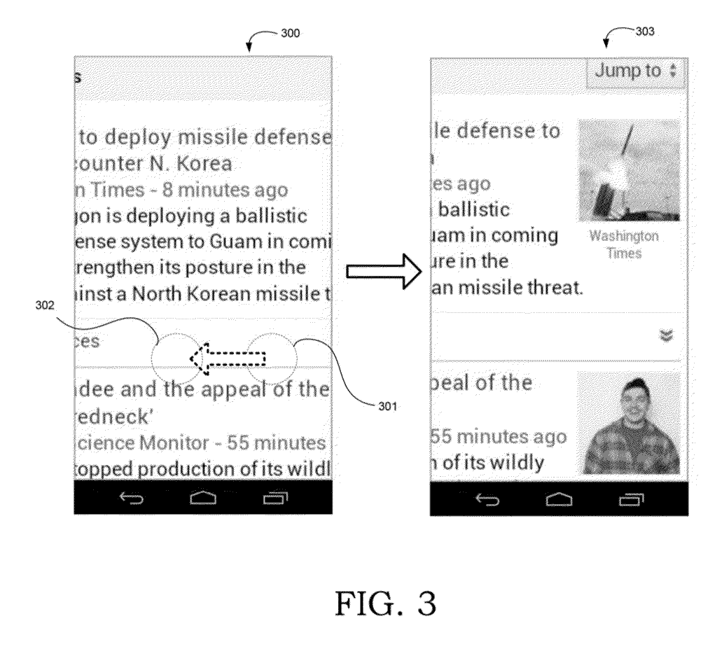

As shown in FIG. 3, the user may also pan the display over the zoomed material in an embodiment. In one implementation, the mobile electronic device is configured such that it interprets a user touch-and-drag action when in the hover-zoom mode as a pan command. As shown in the illustrated example, the user touches the display 300 at a first location 301 and drags the touching digit on the screen to pan the touched material to a second location 302, much like touching and dragging a page of paper. The effect, shown in screen view 303, is that the point of view, sometimes referred to as the viewport, shifts right by the distance of the drag action.

In another embodiment, the mobile device is configured such that a drag action shifts the viewport itself rather than shifting the underlying material. In this embodiment, a leftward drag action would actually pan the point of view, or viewport, to the left, much like panning a camera.

When a user has completed using the hover-zoom mode, he may exit the mode by gesture as well. For example, in an embodiment, the mobile electronic device is configured to interpret one or more actions as a request to exit the mode. In one aspect, if the user lifts the digit out of screen-detection range, then the device is configured to exit the hover-zoom mode. Similarly, if the user touches and then releases the screen, then this may also serve as a request to exit the hover-zoom mode.

In a further embodiment, the mobile electronic device is configured to provide a hover-triggered resize mode. In this aspect, if the user hovers a digit over a spot on the screen for two seconds (or other predetermined time period), then the device will enter the hover-resize mode. In this mode, the device relocates and resizes the displayed material such that the material is visually concentrated closer to the user's digit.

In an aspect of this embodiment, the x-coordinate of the hover point is determined. If the hover x-coordinate is greater than half the screen width from the right, then the user is assumed to be left-handed, and a “resizing-rectangle” is overlaid from the bottom left-hand corner of the display to the hover location, showing the location to which the screen will be resized. If the hover x-coordinate is less than half the screen width from the right, then the user is assumed to be right-handed, and the overlay rectangle is anchored at the bottom right of the display. The overlay rectangle resizes with movement of the user's digit.

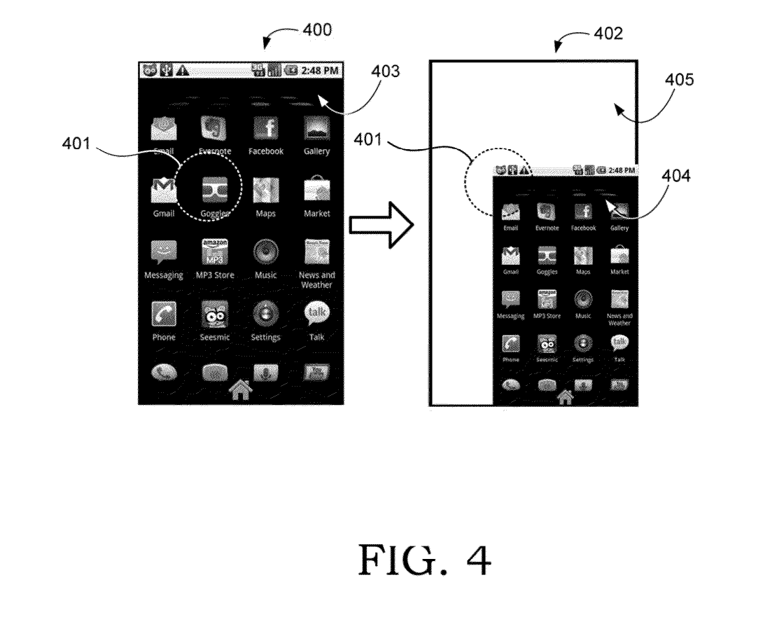

This resizing functionality is illustrated in FIG. 4, which is a simulated screen view showing a manipulation of the mobile electronic device to enter the resize mode by hovering a digit close to the display for a predetermined time in accordance with an aspect of the disclosure. In particular, the hover location is shown as location 401 on display 400. The result of the user hovering a digit in this location 401 is shown in display 402. In display 402, the displayed material 403 has been reduced in scale and relocated such that it starts from the bottom right corner of the screen and has its upper left corner at the coordinates of the triggering hover action.

In an embodiment, the displayed material is resized to a standard size regardless of where the hover action occurs. In this embodiment the decision as to which side will be used to anchor the reduced display may be made by default or may still depend upon the location of the triggering hover action.

The user may exit the resized mode in a number of ways. For example, in an embodiment, the mobile device is configured such that a digit tap on the screen is interpreted as a request to exit the resize mode. In another embodiment, the device in configured to exit the resize mode when the user lifts his digit from the screen. When the resize mode is exited, the device is configured in an embodiment to redraw the display to the last overlay size.

After the display has been resized and anchored, as is shown in FIG. 4, the user may return the display to its normal full scale in any number of ways. In an embodiment, the mobile device is configured such that when the display has been reduced and anchored, receipt of a user touch in the non-displayed area 405 serves as a request to return the display to its full size.

Although the example shown in FIG. 4 illustrates a location-independent resizing mechanism, it will be appreciated that other resizing techniques may be used instead if desired. For example, in an embodiment, the display is resized so that the outer edge of the displayed portion generally follows a radius about a point such as the bottom left or right screen corner. In a further embodiment, the resized displayed material is “fish-eyed” at the location above which the user's finger is located. In this way, user selection of a reduced-size link or icon is more easily executed.

The functions and processes described herein are executed by a computerized device, e.g., the mobile electronic device, via a processor within the device. The processor reads computer-executable instructions from a computer-readable medium and then executes those instructions to perform the appropriate tasks. The computer-executable instructions may also be referred to as “code” or a “program.” The computer-readable medium may be any non-transitory computer-readable medium.

In an embodiment, the instructions for executing the resizing and relocation functions described herein are application-agnostic. That is, the instructions are used by the device to perform global display manipulations regardless of what application or applications may be using display space. As such, in this embodiment, the various applications need not be aware of the display manipulations. Instead, they simply draw their displays as usual, and the device instructions' operating at a higher level make the changes associated with a user hover or touch event.

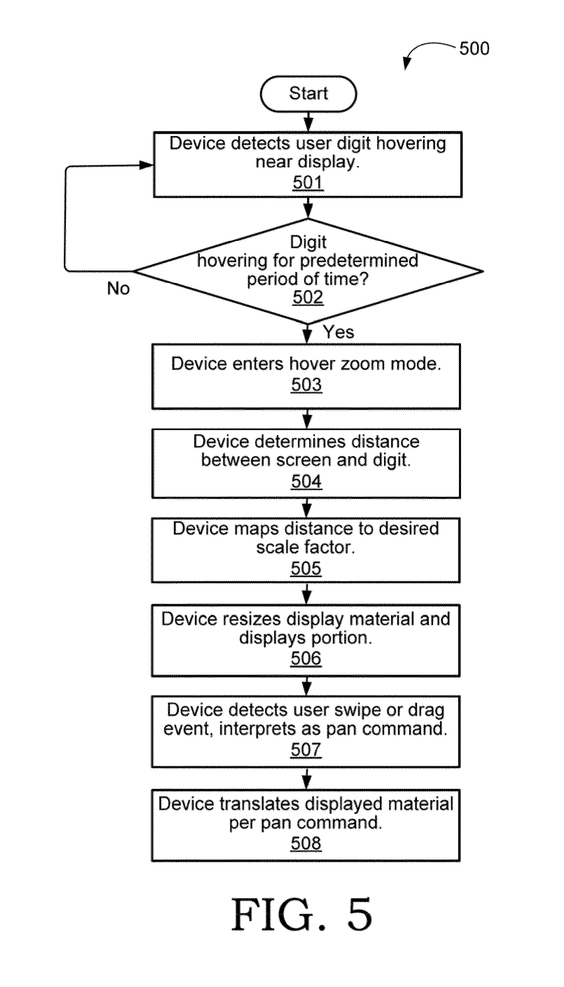

In keeping with the foregoing, FIG. 5 is a flowchart showing a process 500 for intercepting and interpreting user hover and touch events in an embodiment to perform zooming and panning of the display. At stage 501 of the process 500, the device detects a user digit hovering near the display. If the digit remains in a hovering position for a predetermined period of time, as determined at stage 502, then the device enters a hover-zoom mode at stage 503 as described with respect to FIG. 2 above. Otherwise, the process returns to stage 501 to await further hover events.

Once the device has entered the hover-zoom mode, the device is configured to interpret the hover distance as a request for a desired level of zoom or scale. Thus, at stage 504, the distance between the screen and the user's digit is determined, and at stage 505, the determined distance is mapped to a desired scale factor. As noted above, a smaller distance may be mapped to a larger scale factor, and a larger distance may be mapped to a smaller scale factor or vice versa. With the scale factor determined, the device resizes the displayed material and displays all or a portion of the resized material on the device screen at stage 506. As noted above, in an alternative embodiment, changes in hover distance rather than the magnitude of the distance are used to select a desired scale.

At stage 507, the device detects a user swipe or drag event, reflecting that the user has touched the display and then moved the touch point. The device interprets the detected motion as a pan command. As a result, the device translates the displayed material at stage 508 in the direction and by the amount indicated by the drag or swipe. This is referred to as panning the displayed material. In an alternative embodiment, the detected swipe event may be interpreted as panning the point of view or viewport. Thus, in either case, the process 500 allows the user to zoom and pan the display simply and easily via gesturing.

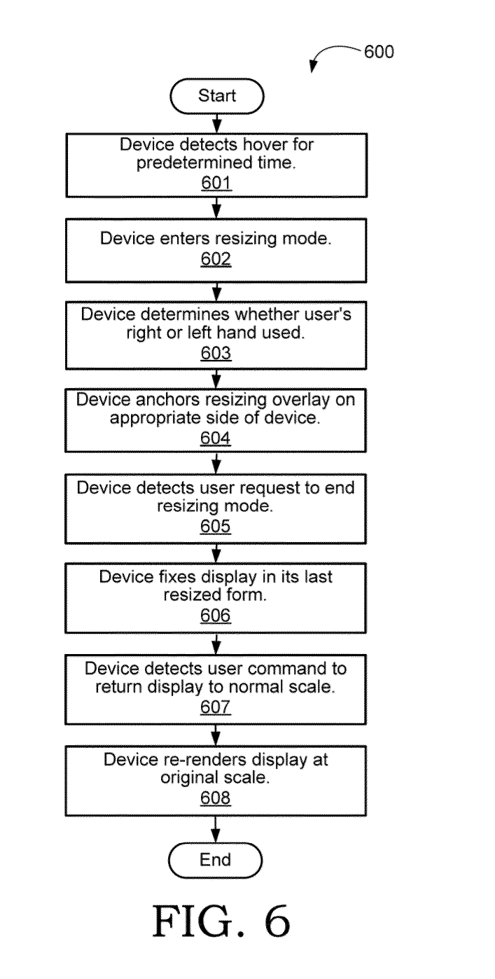

As noted above, the device may also be configured to allow gesture-based resizing and relocation of the displayed material for ease of one-handed use. The process 600 shown in FIG. 6 illustrates the manner in which the device may interpret such gestures in an embodiment. At stage 601 of the process 600, the device detects a hovering event close to the display for a predetermined time and enters a resizing mode at stage 602. At stage 603, the device determines whether the user's right hand or left hand is being used, and at stage 604 the device anchors a resizing overlay on the appropriate side of the device, with one bottom corner of the overlay lying on one bottom corner of the display and the opposite top corner of the overlay lying on the hover location.

At stage 605, the device detects a user request to end the resizing mode, e.g., via a tap on the screen in the displayed area or by the user lifting the digit of interest away from the screen. Subsequently at stage 606, the device fixes the display in its last resized form, that is, with an upper corner resting at the last hover location prior to the end of the resizing mode. As noted above, the user may interact with the resized display.

At stage 607, the device detects a user command to return the display to its normal full scale, e.g., receipt of a user touch in the non-displayed area of the screen. Subsequently at stage 608, the device re-renders the display at its original full size.

It will appreciated that the disclosed principles provide a novel way of enabling user interaction with a mobile electronic device via gestures In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of providing gesture-based user control of a mobile electronic device, the mobile electronic device having a screen with a screen area configured to display visual information, the method comprising:
detecting at the device a persistent presence of a user digit in proximity to the screen; and
in response to detecting the persistent presence of the user digit in proximity to the screen, entering at the device a hover-zoom mode, wherein a distance between the user digit and the screen is used by the device to determine a zoom factor for the display, and wherein a location of the user digit across the screen is used by the device to determine a direction in which, and amount by which, to pan the display.

2. The method of claim 1 wherein detecting at the device a persistent presence of a user digit in proximity to the screen comprises determining that the presence of the user digit in proximity to the screen has persisted for a predetermined period of time.

3. The method of claim 1 further comprising scaling displayed material by the zoom factor to create a resized display and displaying at least a portion of the resized display on the screen.

4. The method of claim 1 wherein using the location of the user digit across the screen to determine a direction in which, and amount by which, to pan the display comprises panning the display in a direction of movement of the user's digit by an amount by which the user's digit has moved.

5. The method of claim 1 wherein using the location of the user digit across the screen to determine a direction in which, and amount by which, to pan the display comprises panning a viewport in a direction of movement of the user's digit by an amount by which the user's digit has moved.

6. The method of claim 3 wherein a location of displayed material on the screen in relation to a location of the user digit when the zoom mode is entered is used to determine a portion of the resized display to display on the screen.

7. A mobile electronic device providing gesture-based user control, the device comprising:
a screen with a screen area configured to display visual information;
one or more proximity sensors associated with the screen; and
a processor configured to detect a persistent presence of a user digit in proximity to the screen, to enter a hover-zoom mode in response to detecting the persistent presence of the user digit in proximity to the screen, to use a distance between the user digit and the screen to determine a zoom factor for the display, and to use a location of the user digit across the screen to determine a direction in which, and an amount by which, to pan the display.

8. The device of claim 7 wherein the processor is further configured to detect the persistent presence of the user digit in proximity to the screen by determining that the presence of the user digit has persisted for a predetermined period of time.

9. The device of claim 7 wherein the processor is further configured to scale displayed material by the zoom factor to create a resized display and to display at least a portion of the resized display on the screen.

10. The device of claim 7 wherein the processor is further configured to pan the display in a direction of movement of the user's digit by an amount by which the user's digit has moved.

11. The device of claim 7 wherein the processor is further configured to pan a viewport in a direction of movement of the user's digit by an amount by which the user's digit has moved.

12. The device of claim 9 wherein the processor is further configured to use a location of displayed material on the screen in relation to a location of the user digit when the zoom mode is entered to determine a portion of the resized display to display on the screen.

13. A method for providing gesture-based user control of a mobile electronic device, the mobile electronic device having a screen with a screen area configured to display visual information, the method comprising:
detecting at the device a persistent presence of a user digit in proximity to the screen; and
in response to detecting the persistent presence of the user digit in proximity to the screen, entering at the device a resizing mode, including using the location of the user digit to determine a resizing point, wherein the resizing point is used by the device to determine a location of a corner of a resized display on the screen.

14. The method of claim 13 wherein the resizing point is used by the device to determine a location of a top corner of the resized display on the screen.

15. The method of claim 13 further comprising determining whether the user digit is a right hand digit or a left hand digit, and using the determination of whether the user digit is a right hand digit or a left hand digit to fix a location of a bottom corner of the resized display against a right side of the screen or a left side of the screen respectively.

16. The method of claim 13 further comprising receiving a user command to exit the resizing mode, whereby a location and size of the resized display then remains fixed regardless of user digit position, allowing user interaction with the resized display.

17. The method of claim 16 wherein the user command to exit the resizing mode comprises a screen tap.

18. The method of claim 16 wherein the user command to exit the resizing mode comprises the user removing the digit from detectable proximity with the screen.

19. The method of claim 13 further comprising receiving a user command to return the display to its original size.

20. The method of claim 19 wherein the user command to return the display to its original size comprises a user touch on the screen outside of the resized display.
